(19) United States
(12) Patent Application Publication
(10) Pub. No.: US 2010/0264728 A1
(43) Pub. Date: Oct. 21, 2010

(54) SYSTEM AND METHOD FOR CREATING AND VERIFYING A COMPOSITE ONBOARD IDENTITY (COBI) FOR A MOBILE ENTITY

(75) Inventor: C. Joseph Rickrode, Nashua, NH (US)

Correspondence Address: Vern Maine & Associates, 547 AMHERST STREET, 3RD FLOOR, NASHUA, NH, 03063-4000, US

(73) Assignee: PERFORMANCE PARTNERS, LLC, Nashua, NH (US)

(21) Appl. No.: 12/761,879

(22) Filed: Apr. 16, 2010

Related U.S. Application Data
(60) Provisional application No. 12/589,540, filed on Apr. 16, 2009.

(51) Int. Cl. B60R 25/10

(52) U.S. Cl. 307/10.2; 340/426.1

(57) ABSTRACT

A system and method for detecting tampering and/or sabotage of a mobile entity obtains initial identity identifying information from a plurality of elements, such as a driver, a vehicle, an item of cargo, and a travel route and/or schedule. A composite onboard identity (“COBI”) is assigned to the mobile entity and is used to retrieve the initial identifying information after the entity arrives at a destination. Final identifying information is then obtained and compared with the initial information, thereby detecting unauthorized changes which indicate tampering or sabotage. Identifying information can also be compared at checkpoints en route. The identifying information can be manually or automatically supplied, and can be wirelessly communicated to a verifying authority. In some embodiments, upon verification failure, an onboard electronic unit can disable the vehicle by stopping the motor, locking the steering wheel, sounding the horn, flashing the lights, and/or applying the brakes.

### RELATED APPLICATIONS

This application claims the benefit of U.S. Provisional Application No. 61/169,739, filed Apr. 16, 2009, incorporated herein by reference in its entirety for all purposes.

### FIELD OF THE INVENTION

The invention relates to systems and methods for creating and verifying security identification, and more particularly to systems and methods for creating and verifying security identification for a vehicle or other mobile entity which is seeking to enter a secure location.

### BACKGROUND OF THE INVENTION

Many methods are known and are in common use for verifying the identity of a person and/or a vehicle attempting to enter a secure location. Examples which are applicable to an individual include comparing the individual's appearance to a photograph, examining an identity card, scanning an electronically readable badge, verifying a spoken password, obtaining and verifying the individual's signature, requiring entry of a special code into a keypad, and even biometric identification such as verifying a fingerprint, voiceprint, and/or retinal scan.

Examples for verifying the identity of a vehicle include comparing the license plate number to a list of authorized license plate numbers, reading and verifying the VIN number, comparing the visual appearance of the vehicle to a previously recorded photograph, and even retrieving a serial number from the CPU which operates the engine of the vehicle, or from other electronics included in the vehicle. Special passes, stickers, and badges can also be issued to vehicles, in a manner which is analogous to the issuing of identity cards and badges to individuals. Of course, combinations of these and other methods can be used so as to further increase security.

Unfortunately, methods exist for defeating all of these identity verification methods. In fact, there are many highly intelligent and technologically skilled individuals who consider it a personal challenge to penetrate or break any new security system as it appears. These skills are also mastered by many terrorists and subversive groups. Details vary, but some of the most common approaches are physically obtaining and copying an identifying card or badge, including any information contained on a magnetic strip etc, obtaining unauthorized access to a computer database containing identifying information, and/or intercepting transmissions of identifying information from vehicles to checkpoints, guard posts, etc. Requiring verification by a plurality of methods can significantly increase the security of a verification protocol, but this can be time consuming and burdensome to legitimate persons and vehicles which require access to a secure facility.

The vulnerability of security precautions is much greater when identifying features are permanent, or at least when they persist for long periods of time. Many security protocols require frequent changes to passwords, entry codes, and such like. However, such frequent changes can also be burdensome to legitimate persons and vehicles which require access to a secure facility.

The need for security is especially acute when sensitive cargo is being transported, and/or when a vehicle is entering or leaving a sensitive and/or secure facility. Examples include delivery and service vehicles entering controlled zones such as Bagdad's Green Zone, vehicles transporting dignitaries or government officials or religious leaders who might be at risk, delivery of materials and access of suppliers and service and maintenance providers to military reservations, transport of dangerous goods such as munitions, explosives, radioactive waste, etc, deliveries to government buildings which are possible targets for potential terrorist truck/van bomb attacks, deliveries and pickup of fuel, service items, food, linens, and freight at airports, and service calls and material deliveries at refineries, chemical plants, etc.

Even when a person or a vehicle is positively identified and authorized, security can still be compromised. For example, valuable cargo transported by an authorized vehicle and driver can be swapped for an empty container, harmless cargo en route to a secure facility can be swapped for a dangerous cargo such as explosives or toxic chemicals, an authorized vehicle can be commandeered and a substitute driver provided, an authorized driver, perhaps having accepted a bribe, may attempt to bring an unauthorized vehicle into a secure facility, and so forth.

What is needed, therefore, is a system and method for verifying the identity of a mobile entity seeking to gain access to a secure facility, whereby the method is highly resistant to unauthorized tampering with any element of the mobile entity, thereby protecting the secure facility from the widest possible range of threats.

### SUMMARY OF THE INVENTION

The present invention is a system and method for detecting unauthorized alterations, tampering, and/or sabotage of a mobile entity seeking to gain access to a secure facility, thereby protecting the secure facility against the widest possible range of threats. Prior art methods have assumed that verification of the identity and/or status of a single element, such as a driver or a vehicle, was sufficient to ensure that a mobile entity had not been tampered with or sabotaged. The present invention shifts the basis of detecting tampering and sabotage from verification of individual elements to simultaneous verification of a plurality of the elements which comprise a mobile entity. The invention thereby increases the likelihood that tampering or sabotage will be detected if any one of the elements of a mobile entity is altered. For example, embodiments of the present invention require that the identities of both a vehicle and a driver be verified before entry into a secure facility is permitted.

According to the present invention, before a mobile entity begins a trip, a plurality of elements pertaining to the mobile entity is selected as requiring verification. Elements which are available for selection in various embodiments include a vehicle, a driver, an item of cargo, a route of travel, and a schedule of travel. Once the plurality of verification elements is selected, initial identifying information is collected for each of the verification elements, according to identifying mechanisms and secure methods known in the art. For example, the driver can be required to display an authorization badge and/or to provide a fingerprint or retinal scan, and encrypted signatures can be used to verify identification provided by the vehicle CPU and by identifying electronics included in the cargo. In some embodiments, a GPS system is included with a vehicle, and information regarding the route and schedule of travel are logged for verification upon arrival.

In various embodiments, at least some of the identifying mechanisms are then disabled in a manner that can only be reversed by an authorized authority. For example, a GPS, an onboard electronic device which reads and reports the serial number of the vehicle CPU, and/or a wirelessly addressable cargo identifier may all be disabled and rendered inaccessible until a highly secure password or key is entered into a controller at the destination, and/or at a checkpoint en route. The identifying mechanisms are thereby further protected against intrusion or hacking while the mobile entity is en route.

Before the mobile entity begins the trip, a composite “onboard” identity, or “COBI,” is assigned to the mobile entity. In some embodiments, the COBI is simply a randomly selected identification number or code, which serves mainly to identify the mobile entity to a verification authority at the destination and/or at one or more checkpoints along the planned route. In these embodiments, the COBI is useful to the verification authority in locating and retrieving the verifying information which has been separately transmitted to the verifying authority. In other embodiments, the initial verifying information is encoded within the COBI, and can be extracted and decoded directly from the COBI by the verifying authority.

Once the initial identifying information has been retrieved, the step of obtaining identifying information from the verification elements of the mobile entity is repeated by the verifying authority, and the newly obtained verifying information is compared with the initial verifying information so as to ensure that no unauthorized changes have been made to the identities and status of any of the verification elements of the mobile entity. In some embodiments, the COBI is then discarded and a new COBI is created for the next trip, even if all of the verification elements of the mobile entity remain the same.

In various embodiments, a route and schedule of travel of the mobile entity is verified by requiring that the mobile entity pass at designated times through designated checkpoints along the route. At each checkpoint, the time and location is noted and logged. In some embodiments, the logged information is stored in an electronic unit on board the mobile entity. In some embodiments, the logged information is encoded into the COBI, so that the COBI evolves during the trip. Subsequent checkpoints then verify that the logged times and locations are consistent with the planned route and schedule. In certain embodiments, the mobile entity is equipped with a GPS system, and data from the GPS is logged and/or automatically encoded into the COBI at designated intervals, so that verification of the identifying information at the destination includes verification that the planned route and schedule were adhered to.

In various embodiments, identifying information is collected and stored by a controller which is external to the mobile entity. In other embodiments, the identifying information is collected by a processor which is on board the mobile entity. In some of the latter embodiments, the onboard processor is able to periodically re-acquire the identifying information, so as to maintain a log thereof and/or to expedite comparison with the initial identifying information by verifying authorities.

In some embodiments, if verification fails, an onboard electronic device will prevent further operation of a vehicle until the failure is resolved. In some of these embodiments, the onboard electronic device is activated by a signal from a verifying authority when verification of the identifying information fails. In other embodiments, the onboard electronic device is able to automatically acquire and verify at least some of the identifying information, and is automatically activated if the verification fails. For example, if an unscheduled driver attempts to operate a vehicle, or if an authorized driver attempts to begin a trip at an unscheduled time, the onboard electronic device will be automatically activated and will prevent the vehicle from starting. In still other embodiments, if the onboard electronic device detects that the mobile entity has deviated from a scheduled route or required time schedule, the onboard electronic device will render the mobile entity inoperable by stopping the motor, applying the brakes, and/or locking the steering wheel.

Note that the term “on board” is used herein to emphasize that the COBI composite identity is associated with a plurality of elements pertaining to a mobile entity while making a trip from a point of origin to a destination. In other words, all of the verification elements are present, or “on board,” during the trip. Also, note that while examples presented herein refer to a single vehicle for simplicity of illustration, it should be understood that the term “mobile entity” can also refer to a plurality of vehicles, traveling either together or separately.

One example of a sequence of events according to an embodiment of the invention used for securing a shipment of explosives or munitions from a manufacturing point to a military base includes the following elements and activities. First, a vehicle and an operator are selected for the shipment, and all existing onboard discrete/unique (electronic, transponder, etc.) identity components, including any operator carried components, such as a badge with a magnetic strip, encrypted bar code, and/or embedded chip, are verified to be functioning properly. Components having a discrete identity might include, but are not limited to, the vehicle's CPU, a vehicle GPS for vehicle routing assistance, a GPS-based monitoring/tracking homing device, a built-in mobile phone, an electronically addressable storage/locking system, and such like.

In some cases, a controller at the departure point, dock, gate, etc. is able to access and store a number of identifying information items, such as the vehicle manufacturer's logo and/or model, license plate number, VIN, company logo on the vehicle, company-defined serial/identity number on the vehicle, and the model, color, shape, and other physical/structural features of the vehicle. In some of these embodiments, the controller is external to the mobile entity, while in other embodiments it is included as an onboard processor on the mobile entity.

Second, a COBI is generated and assigned to the mobile entity. The collection of discrete and unique identifying information items on the vehicle, plus operator-carried and/or physical identity components, and any alternative camera(s), sensor(s) or other forms of detection and recording device(s), are positioned such that all selected aspects of information making up the vehicle's Composite OnBoard Identity can be collected and system-stored in the form of a collective computer and/or processor characteristic, or a similarly functional system of components, which causes the creation of a random and/or encoded sequence of characters, bar codes, numbers, letters and such like as the vehicle's COBI. In various embodiments, the COBI is electronically stored in a memory carried by the vehicle, or simply supplied on an identification tag or printed on identification paperwork carried by the mobile entity.

Third, to the extent possible and practical, all electronic signature-related components on the vehicle are encrypted and/or set to an “OFF” condition on the mobile entity, such that they cannot be read by any unauthorized means until the COBI is retrieved from the vehicle or entered by an authorized authority or operator, or both, followed by a reactivation of the onboard COBI elements by the onboard processor.

Throughout the vehicle's travels, only the assigned COBI, potentially made up of a random and/or encoded sequence of characters, bar codes, numbers, letters and such like, is listed on transport documents and all other communications or listings.

When the COBI is again sensed on the vehicle, or operator entered, or both, at any defined checkpoint or at the final destination, the computerized control system turns “ON” all vehicle-based electronic signature related components and runs through a complete check of each discrete identity element which was pre-selected for verification, so as to determine that no vehicle alterations or compromises of any nature have taken place. This component identity check can be performed in a defined sequence and/or with human intervention by the operator, as designated by the onboard control system.

If a COBI mismatch of any kind is found, and all efforts fail to resolve the problems associated with achieving a COBI verification, i.e., a FAIL condition repeats or persists, the vehicle is disabled, detained, and/or quarantined until security methods (defined by the responsible facility or entity authority) are applied and the identity mismatch is resolved according to the defined response criteria.

### DEFINITIONS

Throughout this disclosure, the following definitions apply.

The term “vehicle” refers to any mobile entity, including an entity moved by another entity such as a cargo container, trailer, etc.

The term “mobile entity” refers to any and all transportable entities, including self-powered vehicles such as autos and trucks as well as entities which are transported by auxiliary means and/or methods, such at transporting trailers, cargo containers, train cars, tankers, etc.

One general aspect of the present invention is a system for detecting unauthorized alteration, tampering, or sabotage of a mobile entity during a trip from a point of origin to a destination. The system includes a plurality of identification mechanisms cooperative with a plurality of elements of the mobile entity, each of the plurality of elements being cooperative with at least one of the identification mechanisms, the identification mechanisms being configured to provide identifying information which can be used to verify at least one of an identity and a status of each of the plurality of elements of the mobile entity. The system further includes a control system configured for obtaining initial identifying information from the identification mechanisms when the mobile entity is at the point of origin, the control system being further configured for assigning to the mobile entity an identifying composite onboard identity signature, herein referred to as a “COBI.” In addition, the system includes a verification system configured for obtaining final identifying information from the identification mechanisms when the mobile entity is at the destination, the verification system also being configured to employ the COBI to obtain the initial identifying information, and to compare the initial identifying information with the final identifying information so as to detect unauthorized alteration, tampering, or sabotage of any of the plurality of elements of the mobile entity.

In various embodiments, at least one of the elements of the mobile entity is a vehicle, a driver, an item of cargo, a route of travel, and a schedule of travel. In certain embodiments, at least one of the identification mechanisms cooperative with an element of the mobile entity is a biometric scanner, a fingerprint scanner, a retinal scanner, a keypad suitable for entering a security code, an identification badge, an identification card, an electronic fob, a license plate, a vehicle identification number plate, an image showing an external appearance of the element of the mobile entity, an electronic device having an identifying number associated therewith, an electronic cargo identification transponder or a global positioning system, herein referred to as a “GPS.”

In some embodiments, the control system is further configured to encode the initial identifying information within the COBI, and the verifying system is configured to extract the initial identifying information from the COBI. In other embodiments, the control system is in wireless communication with at least one of the identification mechanisms. In certain embodiments the control system is external to the mobile entity, and in other embodiments the control system is internal to the mobile entity.

Various embodiments further include an onboard electronic unit which is configured for wireless communication with a verifying authority. Some embodiments further include an onboard electronic unit which is able to prevent the mobile entity from traveling if unauthorized alteration, tampering, or sabotage of any of the plurality of elements of the mobile entity is detected. In some of these embodiments the onboard electronic unit is able to at least one of stop the operation of a vehicle engine, lock a vehicle steering wheel, apply brakes of a vehicle, cause uncontrollable flashing of lights on a vehicle, and cause uncontrollable sounding of a horn of a vehicle.

Another general aspect of the present invention is a method for detecting unauthorized alteration, tampering, or sabotage of a mobile entity during a trip from a point of origin to a destination. The method includes, while the mobile entity is at the point of origin, obtaining initial identifying information which can be used to verify at least one of an identity and a status of each of a plurality of elements of the mobile entity, and assigning to the mobile entity an identifying composite onboard identity signature, herein referred to as a “COBI.” The method further includes, after arrival of the mobile entity at the destination, obtaining final identifying information which can be used to verify at least one of an identity and a status of each of the plurality of elements of the mobile entity, using the COBI, retrieving the initial identifying information, and comparing the initial identifying information with the final identifying information so as to detect unauthorized alteration, tampering, or sabotage of any of the plurality of elements of the mobile entity.

In some embodiments, at least one of the elements of the mobile entity is one of a vehicle, a driver, an item of cargo, a route of travel, and a schedule of travel.

In certain embodiments, at least one of the items of identification is a biometric scan, a fingerprint scan, a retinal scan, a security code, an identification number, a license plate number, a vehicle identification number, herein referred to as a “VIN”, an image showing an external appearance of an element of the mobile entity, a number associated with an electronic device, a number provided by an electronic cargo identification transponder, or a set of location coordinates provided by a global positioning system, herein referred to as a “GPS.”

In various embodiments, the method further includes encoding the initial identifying information within the COBI. And in some of these embodiments retrieving the initial identifying information includes extracting the initial identifying information from the COBI.

In some embodiments retrieving the initial identifying information includes using the COBI to retrieve the initial identifying information from a collection of information. Various embodiments further include, if unauthorized alteration, tampering, or sabotage of any of the plurality of elements of the mobile entity is detected, disabling the mobile entity so that it is incapable of traveling.

And some embodiments further include, if unauthorized alteration, tampering, or sabotage of any of the plurality of elements of the mobile entity is detected, stopping the operation of a vehicle engine of the mobile entity, locking a vehicle steering wheel of the mobile entity, applying the brakes of a vehicle of the mobile entity, locking a vehicle steering wheel of the mobile entity, applying brakes of a vehicle of the mobile entity, causing uncontrollable flashing of lights on a vehicle of the mobile entity, or causing uncontrollable sounding of a horn of a vehicle of the mobile entity.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an illustration of elements of a mobile entity in an embodiment of the present invention;

FIG. 2 is a flow diagram illustrating steps for obtaining verifying information and creating a COBI, according to an embodiment of the present invention; and

FIG. 3 is a flow diagram illustrating steps for verifying identifying information according to an embodiment of the present invention.

### DETAILED DESCRIPTION

The present invention is a system and method for securely verifying the identity and status of a mobile entity seeking to enter a secure facility. According to the invention, a plurality of elements pertaining to the mobile entity is identified as requiring verification. The selected elements are referred to herein as “verification elements.” Before the mobile entity leaves its point of origin, initial identifying information is obtained from each of the verification elements using identification mechanisms and secure methods known in the art. A “composite onboard identity” or “COBI” is assigned to the mobile entity, and is subsequently used in retrieving the initial identifying information, so that it can be compared with identifying information obtained at the destination and/or at checkpoints along the route. By requiring that a plurality of elements be verified, such as a vehicle, a driver, an item of cargo, a route of travel, and/or a schedule of travel, the present invention is able to detect tampering with and/or sabotage of any of the verification elements, and thereby increased protection to the secure facility from a wide range of possible threats.

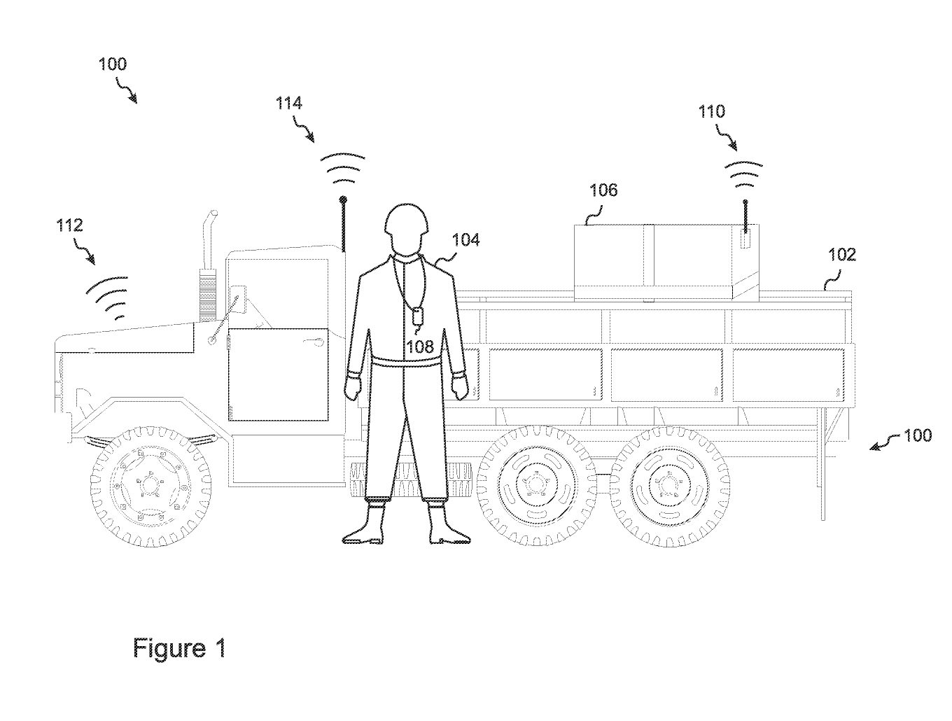

FIG. 1 illustrates a typical “mobile entity” 100, as the term is used herein. The mobile entity 100 includes a plurality of elements, all of which are present or “on board” while the entity 100 travels from a point of origin to a destination.

Specifically, in FIG. 1 the mobile entity 100 includes a vehicle 102, a driver 104, and an item of cargo 106. Clearly, all of these elements 102, 104, 106 must be present or “onboard” before the entity 100 can set out to deliver the cargo 106 to its destination.

According to the present invention, before the mobile entity 100 begins a trip, at least two of the elements 102, 104, 106 of the mobile entity 100 are selected as “verification elements” which require verification. Each of the verification elements must include at least one identity verifying feature from which identifying information can be obtained by a verification mechanism. In the figure, the driver 104 is wearing an identification badge 108, which can serve as an identifying feature. In various embodiments, a card reader can be used as a verification mechanism to read an identification number from the badge 108. In that instance, the identification number then serves as at least one item of “identifying information” for the driver 104. In similar embodiments, a detector can automatically detect an electronic “fob” carried by the driver 104, or a fingerprint and/or retinal scanner can be used to obtain a biometric scan from the driver.

The cargo 106 in the embodiment of FIG. 1 includes a tamper-proof electronic identification unit 110 which can be wirelessly queried and which uses electronic signature technology to resist spoofing and other forms of hacking and imitation. The vehicle 102 includes a CPU cooperative with the engine of the vehicle 102, and an onboard electronic device 112 which is cooperative with the CPU and which is able to read a serial number of the CPU and wirelessly transmit the serial number to a verifying authority. In the embodiment of FIG. 1, the onboard electronic device 112 can also be wirelessly accessed so as to store and retrieve an assigned COBI. In some embodiments, the onboard electronic device 112 is able to obtain some or all of the verifying information, either automatically or by manual input.

In the embodiment of FIG. 1, the onboard electronic device 112 is further able to prevent the engine from operating until it receives an authorizing signal from a verification authority. The driver 104 will therefore not be able to operate the vehicle 102 until all of the required identifying information has been received in the proper sequence. In particular, none of the individual items of identifying information is adequate in or of itself to enable operation of the mobile entity 100, which is protected by the COBI concept of the present invention. Pre-defining a sequence in which the items of identifying information must be received further increases the security level of the composite onboard identity.

In the embodiment of FIG. 1, the vehicle 102 is further equipped with a GPS 114. As the vehicle 102 travels, time and location information is logged by the GPS 114. Upon arrival at the destination and/or at checkpoints along the route, the logged information is supplied by the GPS to a verifying authority as verifying information, thereby ensuring that the mobile entity 100 has followed a required route and schedule. In similar embodiments, the vehicle is required to pass through checkpoints along its route. Each checkpoint transmits encoded information to the onboard electronic unit 112, which maintains a log of times at which checkpoints were reached, so as to verify to subsequent checkpoints that the route and schedule have been adhered to.

It should be clear that the present invention includes many alternatives known in the art for securely verifying the identity and/or status of persons, vehicles, items of cargo, routes of travel, schedules of travel, and other elements which pertain to a mobile entity traveling from a point of origin to a destination. In various embodiments, an authorized user of the present invention can select and define the number and types of elements which require verification, and/or the order in which the identifying information items must be received. In some of these embodiments, an authorized user can periodically re-define the number and sequence of verification elements for added security.

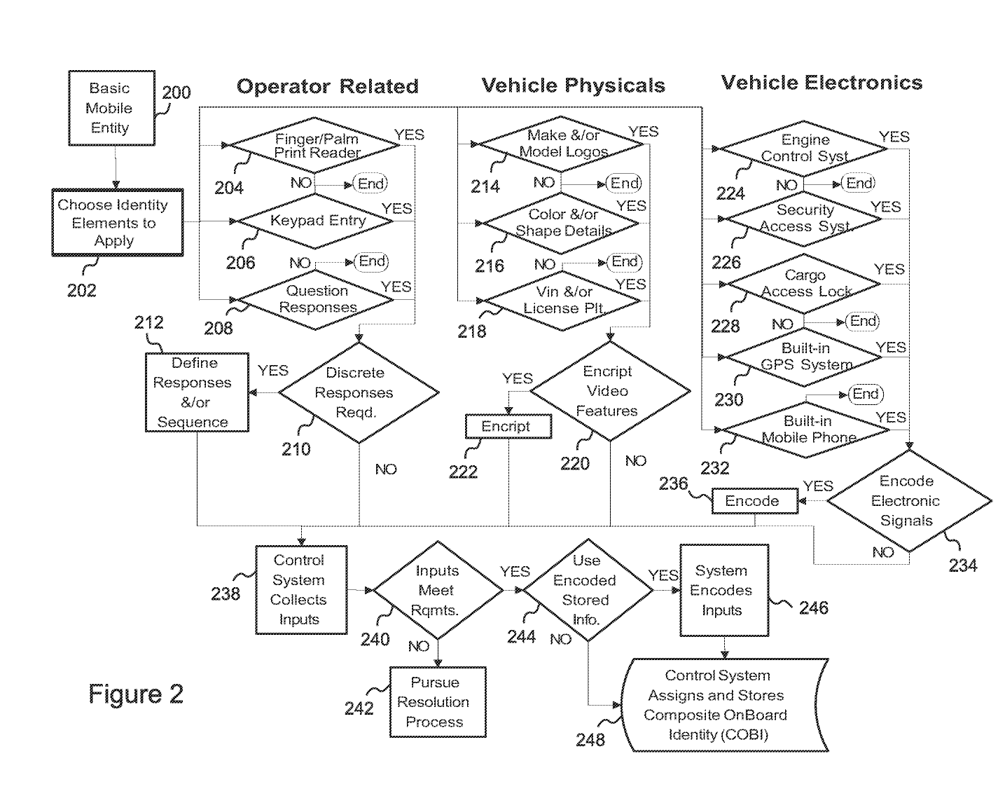

FIG. 2 is a flow diagram which illustrates steps and decisions which are followed in an embodiment of the invention to define a set of verification elements, record initial identifying information, and generate a COBI. Beginning with a basic mobile entity 200, such as a car, panel truck, van, tractor trailer, box car, or cargo container, verification elements are identified 202 from which verifying information will be required. For example, in the embodiment of FIG. 1 these might include the vehicle 102, the driver or operator 104 of the vehicle 102, and the cargo 106, as well as time and location information acquired by an onboard GPS 114.

Once the verification elements have been defined, means must be selected for obtaining and verifying identifying information from each of the verification elements. For example, the vehicle operator 104 may be identified by any or all of a fingerprint or palm reader 204, entry of a specific code into a keypad 206, and/or responding correctly to specific challenge questions 208, possibly to establish and verify a voiceprint. Once the identification mechanisms, and/or methods have been defined 210, the required responses are identified 212. If more than one method is to be used, then security can be further enhanced by requiring that the methods be applied in a specified order or sequence 212.

This process is essentially repeated with regard to the vehicle 102. Outwardly visible features of the vehicle can be verified, such as the make and/or model of the vehicle 214, the color, shape, and other visible details 216, and the VIN number and/or license plate number 218. These visual features are then recorded by video 220 and stored 222 in encrypted form. In addition, various electronic features included with the vehicle 102 can be queried, so as to obtain and verify their serial numbers. These include the CPU of the engine control system 224, the vehicle anti-theft security system 226, a cargo-access lock 228, a built-in GPS system 114, 230, and a built-in mobile phone 232. The electronic information obtained from each of these electronic devices is then encoded 234 (and possibly encrypted), and stored 236.

Once all of the elements and identification methods have been defined, the required information 238 is collected, and a determination is made as to whether all of the requirements have been met 240. If not, an appropriate resolution process is initiated 242. Otherwise, in various embodiments, the collected information is combined 244 with additional information and encoded 246, and a system controller creates and stores a COBI 248. In some embodiments, the system controller is external to the mobile entity, while in other embodiments it is an onboard processor incorporated into the mobile entity. In some embodiments the COBI is simply an identifier for the mobile entity, which may be randomly generated. In other embodiments, the identifying information is encoded within the COBI.

It should be noted with regard to FIG. 2 that the selection of verification elements will vary according to characteristics of the mobile entity 100 and applicable security requirements. Some verification elements may permit changing of their codes and/or serial numbers, and some verification elements may include encrypted access. Also, in the embodiment of FIG. 2, the type and extent of identity elements is user-defined. In some embodiments, the system will deactivate and/or turn-off selected electronic codes to ensure the security of their identities, and communications to and from the onboard electronic unit 112 will be encrypted in certain embodiments.

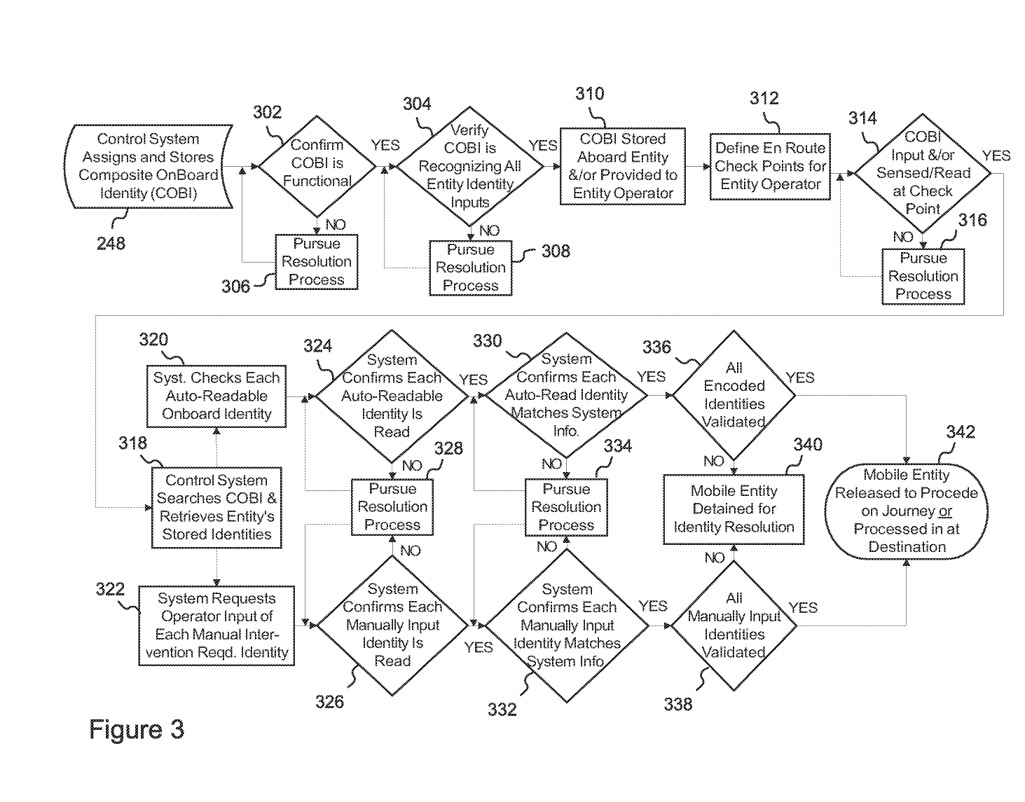

FIG. 3 is a flow diagram which illustrates steps that are followed in various embodiments after the initial identifying information has been recorded and the COBI has been created. Before the mobile entity 100 has departed from its point of origin, the control system verifies that it is possible to switch on all required identity recognizing mechanisms 302, and that all required identifying information can be obtained from all of the verification elements 304. If not, then an appropriate resolution procedure is initiated 306, 308. The COBI is then stored in the electronic unit 112 and/or provided 310 to the operator 104 of the vehicle 102. In various embodiments, en route checkpoints are defined 312 and communicated to the operator 104 of the vehicle 102. In some embodiments, these are physical checkpoints that the mobile entity is required to visit along its route. In other embodiments, they are times and/or locations through which the mobile entity is required to pass, whereby compliance is logged by the onboard GPS 114.

As each checkpoint is reached, the COBI is communicated to a verifying authority 314. If the COBI is not received, an appropriate resolution procedure is initiated 316. Otherwise, depending on the embodiment, the initial verifying information is either retrieved from information previously transmitted to the checkpoint from the point of origin, or extracted directly from the COBI 318. The system then checks the automatically readable information items 320 of the mobile entity 100, such as the serial number of the engine CPU, and requests manual input 322 of the manually readable items, such as a fingerprint or retinal scan of the driver 104. The system confirms that the automatically readable items 324 and the manually input items 326 have been read, and that they agree 330, 332 with the initial identifying information. If they don't agree, then an appropriate resolution procedure is initiated 328, 334. The information items are then further validated against a list of known, authorized elements 336, 338. If the validation fails, the mobile entity 100 is detained for identity resolution 340. Otherwise, the mobile entity 100 is released to continue its journey, or processed in at its final destination 342.

With reference to FIG. 3, it should be noted that in some embodiments the onboard electronic unit 112 is programmed to cancel the COBI, disable the vehicle, and/or alert a verifying authority if tampering is detected. In some embodiments, an identity subset is defined, which is to be confirmed at selected checkpoints, for example where only remote verification electronics are available. In some embodiments, the system is able to change individual component electronic identities en route, so as to increase security still further.

In certain embodiments wherein the identifying information is encoded within the COBI, an onboard processor 112 re-generates the COBI upon arrival at the destination and/or at checkpoints en route. The COBI is then verified as a whole by the verifying authority, by comparing it to a pre-authorized COBI which has been transmitted to the checkpoint or final destination in anticipation of the arrival of the mobile entity 100.

In various embodiments, if verification of the identifying information fails, the resolution process 328, 334, 340 includes disabling of the vehicle 102 activation by the electronic unit 112 and/or by other system elements. For example, in some embodiments if an unscheduled driver 104 attempts to operate the vehicle 102, or if an authorized driver 104 attempts to begin a trip at an unscheduled time, an onboard processor 112 will detect the unauthorized activity and will prevent the vehicle 102 from starting. In other embodiments, if the mobile entity 100 deviates from a scheduled route or time schedule, an onboard electronic unit 112 will cause the mobile entity 100 to become inoperable, due to stopping of the motor, application of the breaks, locking of the steering wheel causing uncontrollable flashing of lights on the vehicle, and/or causing uncontrollable sounding of a horn of the vehicle. In still other embodiments, a verifying authority is able to transmit a signal to the onboard electronic unit 112, causing it to disable the vehicle 102 and force a trip to terminate.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for detecting unauthorized alteration, tampering, or sabotage of a mobile entity during a trip from a point of origin to a destination, the system comprising:
a plurality of identification mechanisms cooperative with a plurality of elements of the mobile entity, each of the plurality of elements being cooperative with at least one of the identification mechanisms, the identification mechanisms being configured to provide identifying information which can be used to verify at least one of an identity and a status of each of the plurality of elements of the mobile entity;
a control system configured for obtaining initial identifying information from the identification mechanisms when the mobile entity is at the point of origin, the control system being further configured for assigning to the mobile entity an identifying composite onboard identity signature, herein referred to as a “COBI”; and
a verification system configured for obtaining final identifying information from the identification mechanisms when the mobile entity is at the destination, the verification system also being configured to employ the COBI to obtain the initial identifying information, and to compare the initial identifying information with the final identifying information so as to detect unauthorized alteration, tampering, or sabotage of any of the plurality of elements of the mobile entity.

2. The system of claim 1 wherein at least one of the elements of the mobile entity is a vehicle, a driver, an item of cargo, a route of travel, and a schedule of travel.

3. The system of claim 1 wherein at least one of the identification mechanisms cooperative with an element of the mobile entity is one of:
a biometric scanner;
a fingerprint scanner;
a retinal scanner;
a keypad suitable for entering a security code;
an identification badge;
an identification card;
an electronic fob;
a license plate;
a vehicle identification number plate;
an image showing an external appearance of the element of the mobile entity;
an electronic device having an identifying number associated therewith;
an electronic cargo identification transponder; and
a global positioning system, herein referred to as a “GPS.”

4. The system of claim 1, wherein the control system is further configured to encode the initial identifying information within the COBI, and the verifying system is configured to extract the initial identifying information from the COBI.

5. The system of claim 1, wherein the control system is in wireless communication with at least one of the identification mechanisms.

6. The system of claim 1, wherein the control system is external to the mobile entity.

7. The system of claim 1, wherein the control system is internal to the mobile entity.

8. The system of claim 1, further comprising an onboard electronic unit which is configured for wireless communication with a verifying authority.

9. The system of claim 1, further comprising an onboard electronic unit which is able to prevent the mobile entity from traveling if unauthorized alteration, tampering, or sabotage of any of the plurality of elements of the mobile entity is detected.

10. The system of claim 9, wherein the onboard electronic unit is able to at least one of stop the operation of a vehicle engine, lock a vehicle steering wheel, apply brakes of a vehicle, cause uncontrollable flashing of lights on a vehicle, and cause uncontrollable sounding of a horn of a vehicle.

11. A method for detecting unauthorized alteration, tampering, or sabotage of a mobile entity during a trip from a point of origin to a destination, the method comprising:
while the mobile entity is at the point of origin, obtaining initial identifying information which can be used to verify at least one of an identity and a status of each of a plurality of elements of the mobile entity;
assigning to the mobile entity an identifying composite onboard identity signature, herein referred to as a “COBI”;
after arrival of the mobile entity at the destination, obtaining final identifying information which can be used to verify at least one of an identity and a status of each of the plurality of elements of the mobile entity;
using the COBI, retrieving the initial identifying information; and
comparing the initial identifying information with the final identifying information so as to detect unauthorized alteration, tampering, or sabotage of any of the plurality of elements of the mobile entity.

12. The method of claim 11 wherein at least one of the elements of the mobile entity is one of a vehicle, a driver, an item of cargo, a route of travel, and a schedule of travel.

13. The method of claim 11 wherein at least one of the items of identification is one of:
a biometric scan;
a fingerprint scan;
a retinal scan;
a security code;
an identification number;
a license plate number;
a vehicle identification number, herein referred to as a “VIN”;
an image showing an external appearance of an element of the mobile entity;
a number associated with an electronic device;
a number provided by an electronic cargo identification transponder; and
a set of location coordinates provided by a global positioning system, herein referred to as a “GPS.”

14. The method of claim 11, wherein the method further includes encoding the initial identifying information within the COBI.

15. The method of claim 14, wherein retrieving the initial identifying information includes extracting the initial identifying information from the COBI.

16. The method of claim 11, wherein retrieving the initial identifying information includes using the COBI to retrieve the initial identifying information from a collection of information.

17. The method of claim 11, further comprising, if unauthorized alteration, tampering, or sabotage of any of the plurality of elements of the mobile entity is detected, disabling the mobile entity so that it is incapable of traveling.

18. The method of claim 11, further comprising, if unauthorized alteration, tampering, or sabotage of any of the plurality of elements of the mobile entity is detected, at least one of:
stopping the operation of a vehicle engine of the mobile entity;
locking a vehicle steering wheel of the mobile entity;
applying the brakes of a vehicle of the mobile entity;
locking a vehicle steering wheel of the mobile entity;
applying brakes of a vehicle of the mobile entity;
causing uncontrollable flashing of lights on a vehicle of the mobile entity; and
causing uncontrollable sounding of a horn of a vehicle of the mobile entity.
